(19) United States
(12) Patent Application Publication
(10) Pub. No.: US 2024/0124359 A1
(43) Pub. Date: Apr. 18, 2024

(54) COMPOSITE MATERIAL AND PROCESS FOR MANUFACTURING SAME

(71) Applicant: GESTION DU PONT COUVERT INC., Québec (CA)

(72) Inventor: Denis Girard, Québec (CA)

(21) Appl. No.: 18/486,320

(22) Filed: Oct. 13, 2023

Related U.S. Application Data
(60) Provisional application No. 63/379,545, filed on Oct. 14, 2022.

(51) Int. Cl. C04B 28/14; C04B 18/24; C04B 18/26; C04B 38/10

(52) U.S. Cl. CPC C04B 28/14; C04B 18/241; C04B 18/26; C04B 38/10; C04B 2111/00129

(57) ABSTRACT

There is provided composite materials that include a plastic polymer and gypsum for use as a building material and methods of fabricating the building material. The composite material can include a foaming agent configured to reduce the density of the composite material. The composite material can be extruded or injection molded into a building material form that can include an elongated, rectangular form. The building material can be used as a wood replacement for wooden building materials. The plastic polymer can include linear low-density polyethylene (LLDPE), low-density polyethylene (LDPE), high-density polyethylene (HDPE), and/or acrylonitrile butadiene styrene (ABS). The composite material can include a filler, such as wood flour or saw dust.

### CROSS-REFERENCE TO RELATED APPLICATIONS

This application claims priority under 35 U.S.C. § 119(e) of U.S. Provisional Patent Application No. 63/379,545 filed Oct. 12, 2022, the specification of which is hereby incorporated by reference.

### TECHNICAL FIELD

The technical field generally relates to composite materials and methods for manufacturing the same. Specifically, the present document relates to composite materials of plastic polymers and gypsum for use as building materials.

### BACKGROUND

Building materials comprising wood, such as dimensional lumber, wooden slats, or nail strips, are used in a number of construction operations. However, wood products, whether in use or in storage, are prone to deterioration by microorganisms or insects and are susceptible to damage from water. Furthermore, as a natural product, wood products can be prone to certain defects or other undesirable features that affect the structure and/or appears of the final product, such as wane, knots, splits, torsion, camber, curvature, honeycomb decay, and the like.

In view of the above, there is a need for a more cost-effective building material that would be able to overcome or at least minimize some of the above-discussed concerns.

### SUMMARY

It is therefore an aim of the present invention to address the above-mentioned issues.

According to one aspect, there is provided a composite material, the composite material comprising: at least 40% w/w of a plastic polymer; and up to 45% w/w gypsum. In some embodiments, the composite material comprises at least 65% w/w of the plastic polymer.

In some embodiments, the plastic polymer is a thermoplastic or a matrix of at least two thermoplastics.

In some embodiments, the plastic polymer includes a polyethylene.

In some embodiments, the polyethylene is at least one of linear low-density polyethylene (LLDPE), low-density polyethylene (LDPE), high-density polyethylene (HDPE), ultra-high-molecular-weight polyethylene (UHMWPO), cross-linked polyethylene (PEX or XLPE), medium-density polyethylene (MDPE), and very-low-density (VLDPE).

In some embodiments, the plastic polymer comprises at least one of: linear low-density polyethylene (LLDPE), low-density polyethylene (LDPE), high-density polyethylene (HDPE), and acrylonitrile butadiene styrene (ABS).

In some embodiments, the plastic polymer comprises a matrix of LLDPE or LDPE and HDPE. For instance, the plastic polymer can comprise between about 65% and about 90% LLDPE or LDPE and between about 0% and about 35% HDPE or the plastic polymer can comprise between about 65% and about 90% HDPE and between about 0% and about 35% LLDPE or LDPE.

In some embodiments, the matrix comprises about 75% LLDPE or LDPE and about 25% HDPE.

In some embodiments, the plastic polymer comprises at least 5% ABS. In some embodiments, the plastic polymer comprises up to 10% ABS.

In some embodiments, the plastic polymer comprises about 90% w/w LLDPE or LDPE and about 10% w/w ABS.

In some embodiments, the composite material comprises at least 56% w/w of the plastic polymer and about 43% w/w of the gypsum.

In some embodiments, the composite material comprises about 66% w/w plastic polymer and about 33% w/w gypsum.

In some embodiments, the composition material further comprises up to 15% wt filler, such as wood flour, cardboard, saw dust, and mixtures thereof.

In some embodiments, the composition material further comprises between 0.2 and 6% w/w of a foaming agent.

In some embodiments, the foaming agent is azodicarbonadmide (ADCA), p,p′Oxybis(benzene) sulfonyl hydrazide (OBSH), p-Toluene sulfonyl hydrazide (TSH), p-Toluene sulfonyl semicarbazide (TSS), dinitrosopenta-methylenetetramine (DNPT), 5-Phenyltetrazole (5PT), sodium bicarbonate, citric acid, sodium borohydride (SBH), or a mixture thereof.

In some embodiments, the foaming agent is a mixture of citric acid and sodium bicarbonate.

In some embodiments, the foaming agent is citric acid.

In some embodiments, the composite material comprises between about 0.5 wt % and about 3.5 wt % citric acid.

In some embodiments, the foaming agent is sodium bicarbonate.

In some embodiments, the composite material comprises between about 3 wt % and about 6 wt % sodium bicarbonate.

In some embodiments, the composite material comprises a foamed material.

In some embodiments, the composite material is extruded or injection molded into a building material.

In some embodiments, the building material is configured as a wood replacement.

In some embodiments, the building material comprises at least one cavity.

In some embodiments, the at least one cavity extends longitudinally through the building material.

In some embodiments, the at least one cavity has a diameter that is between about 10% and about 75% of a thickness of the building material.

In some embodiments, the diameter of the at least one cavity is between about 50% and about 70% of the thickness of the building material.

In some embodiments, the diameter of the at least one cavity is between about ⅜ of an inch to about ½ of an inch. According to another aspect, there is provided a method of fabricating a product, the method comprising: mixing at least 40% w/w of a plastic polymer and up to 45% w/w gypsum to produce a composite material; and extruding or injection molding the composite material into a form to produce the product. In some embodiments, the method further comprises drying the gypsum prior to compounding the plastic polymer and the gypsum.

In some embodiments, the method further comprises providing a devolatilization port during the compounding of the plastic polymer and the gypsum. The devolatilization port can be provided with a pressure equal to or less than atmospheric pressure.

In some embodiments, the plastic polymer is a thermoplastic or a matrix of at least two thermoplastics.

In some embodiments, the plastic polymer includes a polyethylene.

In some embodiments, the polyethylene is at least one of linear low-density polyethylene (LLDPE), low-density polyethylene (LDPE), high-density polyethylene (HDPE), ultra-high-molecular-weight polyethylene (UHMWPO), cross-linked polyethylene (PEX or XLPE), medium-density polyethylene (MDPE), and very-low-density (VLDPE).

In some embodiments, the plastic polymer comprises at least one of: linear low-density polyethylene (LLDPE), low-density polyethylene (LDPE), high-density polyethylene (HDPE), and acrylonitrile butadiene styrene (ABS).

In some embodiments, the method further comprises mixing a foaming agent with the composite material to produce a foamed composite material and extruding or injection molding the foamed composite material.

In some embodiments, the foaming agent is azodicarbonadmide (ADCA), p,p′Oxybis(benzene) sulfonyl hydrazide (OBSH), p-Toluene sulfonyl hydrazide (TSH), p-Toluene sulfonyl semicarbazide (TSS), dinitrosopenta-methylenetetramine (DNPT), 5-Phenyltetrazole (5PT), sodium bicarbonate, citric acid, sodium borohydride (SBH), or a mixture thereof.

In some embodiments, the foaming agent is a mixture of citric acid and sodium bicarbonate.

In some embodiments, the form is a building material form and the product is a building material.

In some embodiments, the building material form is in a dimensional lumber shape.

In some embodiments, the building material form has a shape that provides at least one cavity in the building material.

In some embodiments, the at least one cavity extends longitudinally through the building material.

In some embodiments, the building material form provides a chamfered, beveled, or filleted edge on at least one edge of the building material.

According to yet another aspect, there is provided a building material comprising a composite material extruded or injection molded into a form, the composite material comprising at least 40% w/w of a plastic polymer and up to 45% w/w gypsum.

In some embodiments, the plastic polymer is a thermoplastic or a matrix of at least two thermoplastics.

In some embodiments, the plastic polymer includes a polyethylene.

In some embodiments, the polyethylene is at least one of linear low-density polyethylene (LLDPE), low-density polyethylene (LDPE), high-density polyethylene (HDPE), ultra-high-molecular-weight polyethylene (UHMWPO), cross-linked polyethylene (PEX or XLPE), medium-density polyethylene (MDPE), and very-low-density (VLDPE).

In some embodiments, the plastic polymer comprises at least one of: linear low-density polyethylene (LLDPE), low-density polyethylene (LDPE), high-density polyethylene (HDPE), and acrylonitrile butadiene styrene (ABS).

In some embodiments, the plastic polymer comprises a matrix of LLDPE or LDPE and HDPE.

In some embodiments, the matrix comprises about 75% LLDPE or LDPE and about 25% HDPE.

In some embodiments, the composite material comprises at least 56% w/w of the plastic polymer and about 43% w/w of the gypsum.

In some embodiments, the composite material comprises about 66% w/w plastic polymer and about 33% w/w gypsum.

In some embodiments, the building material further comprises between 0.2 and 6% w/w of a foaming agent.

In some embodiments, the foaming agent is azodicarbonadmide (ADCA), p,p′Oxybis(benzene) sulfonyl hydrazide (OBSH), p-Toluene sulfonyl hydrazide (TSH), p-Toluene sulfonyl semicarbazide (TSS), dinitrosopenta-methylenetetramine (DNPT), 5-Phenyltetrazole (5PT), sodium bicarbonate, citric acid, sodium borohydride (SBH), or a mixture thereof.

In some embodiments, the foaming agent is citric acid.

In some embodiments, the composite material comprises 0.5% citric acid.

In some embodiments, the foaming agent is sodium bicarbonate.

In some embodiments, the composite material comprises 3% sodium bicarbonate.

In some embodiments, the form is an elongated form.

In some embodiments, the elongated form is a dimensional lumber form.

In some embodiments, the dimensional lumber form is one of: a 1×2, a 1×3, a 1×4, a 2×4, a 2×6, a 2×8, a 2×10, a 4×4, a 6×6, and a 10×10.

In some embodiments, at least one edge of the elongated form is chamfered, beveled, or filleted.

In some embodiments, the building material further comprises at least one cavity extending longitudinally through the elongated form.

In some embodiments, the at least one cavity has a diameter that is between about 10% and about 75% of a thickness of the elongated form.

In some embodiments, the diameter of the at least one cavity is between about 50% and about 70% of the thickness of the elongated form.

In some embodiments, the diameter of the at least one cavity is between about ⅜ of an inch to about ½ of an inch.

In some embodiments, the elongated form has a thickness of between ¼ an inch and about 8 inches.

In some embodiments, the elongated form has a thickness of between ⅝ of an inch and 2 inches.

In some embodiments, the elongated form has a width of between ½ inches and 10 inches.

In some embodiments, the width of the elongated form is between 2 inches and 6 inches.

In some embodiments, the form is a sheet form.

In some embodiments, the sheet form has a thickness of between ¼ an inch and about 1 inch.

In some embodiments, the elongated form has a width of between 6 inches and 8 feet.

### BRIEF DESCRIPTION OF THE DRAWINGS

In order that the invention may be readily understood, embodiments of the invention are illustrated by way of example in the accompanying drawings.

FIG. 1 is a cross-sectional photographic view of a foamed composite material according to one embodiment;

FIG. 2A is a perspective side view of a building material product made from a composite material according to another embodiment with internal cavities extending longitudinally therein;

FIG. 2B is a perspective view of a building material product made from a composite material according to another embodiment with longitudinally extending internal cavities and beveled edges;

FIG. 3 is a process flow chart showing a method of producing a building material product comprising a composite material according to another embodiment;

FIG. 4 is a cross-sectional photographic view of a building material product comprising foamed composite material according to another embodiment;

FIG. 5 is a cross-sectional photographic view of a building material product comprising foamed composite material according to another embodiment;

FIG. 6 is a photograph of a front elevation view of a building material product comprising foamed composite material according to another embodiment;

FIG. 7 is a photograph of perspective front view of a building material product comprising foamed composite material according to another embodiment;

FIG. 8 is a front perspective photographic view of a building material product and a counterpart wood building material after having undergone a nail penetration and retention test;

FIG. 9 is a perspective front view of a building material product comprising a non-foamed composite material according to another embodiment;

FIG. 10 is a graphical representation of a thermogravimetric analysis (TGA) expressed as weight (%) over temperature (° C.) and the differential thermal analysis (DTA) curve expressed as heat flow (W/g) over temperature (° C.) for non-dried recycled gypsum;

FIGS. 11 and 11A are graphical representations of a thermogravimetric analysis showing the mineral content of the composite material expressed as weight (%) over temperature (° C.);

FIGS. 12A and 12B are graphical representations of a flexural modulus test expressed as flexural stress (MPa) over strain (%) for examples 22, 23, and 26 (FIG. 12A) and examples 23 to 26 (FIG. 12B); and

FIGS. 13A and 13B are graphical representations of a water moisture test expressed as water absorption (% wt) over the number of days for example 22 (FIG. 13A) and examples 23 to 26 (FIG. 13B).

### DETAILED DESCRIPTION

There is provided composite materials that include a mixture of plastic polymer and gypsum (or calcium sulfate dihydrate) for use as a building material. In some embodiments, the plastic polymer and/or the gypsum can be recycled or recovered from a waste recovery facility. For example, the plastic polymer can include up to 100% recycled plastic and the gypsum can be recycled or recovered gypsum, for example from demolished or defective drywall panels.

The mixture of plastic polymer and gypsum reduces the overall content of plastic, while maintaining or increasing the structural strength and the elasticity of the resulting building material product. The mixture of plastic polymer and gypsum can also provide resistance to aging or degradation of the building material product that is caused by weather, microorganisms, etc.

In some embodiments, the composite material can include a foaming agent configured to release gas upon thermal decomposition and reduce the density of the composite material. The composite material can be extruded into a building material form that can include an elongated, substantially rectangular form. The building material can be used as a wood replacement for wooden building materials, such as dimensional lumber, plywood or oriented strand board (OSB) sheets, medium density fiberboards (MDF), wooded slats, nail strips, and the like.

The composite material can be fabricated by mixing a plastic polymer and gypsum to produce a homogenous or near-homogenous composite mixture. When the composite material includes a foaming agent, the foaming agent can be mixed with the composite mixture prior to foaming the composite mixture. The composite mixture can be foamed through the application of heat, for example by heating the composite mixture to a temperature between about 110° C. and about 250° C., depending on the type of foaming agent used. The foamed or non-foamed composite mixture can then be extruded into a shape suitable as a building material, such as an elongated rectangular shape. In some embodiments, the overall weight of the extruded building material can be reduced by including internal cavities in the building material, at a size that allows the building material to retain the building material's tensile strength (resistance to breaking force) and flexural modulus.

In some embodiments, the plastic polymer is a thermoplastic and can include polyethylene plastic, such as linear low-density polyethylene (LLDPE), low-density polyethylene (LDPE), high-density polyethylene (HDPE), ultra-high-molecular-weight polyethylene (UHMWPO), cross-linked polyethylene (PEX or XLPE), medium-density polyethylene (MDPE), very-low-density (VLDPE), and/or other thermoplastics, such as acrylonitrile butadiene styrene (ABS). The plastic polymer can include up to 100% polyethylene, such as 100% LLDPE, 100% LDPE, or 100% HDPE. In some embodiments, the plastic polymer includes ratio of different types of polyethylene plastics, such as a ratio of LLDPE or LDPE and HDPE (LLDPE or LDPE/HDPE) up to 90/10, including up to 75/25, up to 66.66/33.33, up to 50/50, 2 up to 5/75, or at least 10/90. For example and without being limitative, the composite material can include a plastic polymer that is a matrix of 90 wt % LLDPE and 10 wt % ABS.

The plastic polymer can be a recycled plastic polymer. For instance and without being limitative, low-density polyethylene (LDPE) and/or LLDPE can be recycled hay wrapping material or bags and the HDPE can be recycled HDPE containers (e.g. detergent and milk containers). In some embodiments, residual material, such a vegetal matter, can be introduced into the mixture of plastic polymer and gypsum. Similarly, fillers such as cardboard or wood flour can be introduced simultaneously with the gypsum into the mixture of plastic polymer and gypsum.

### Properties of Raw Materials

TABLE 1

| Material | Density (g/cm³) | Volume (cm³/g) |
|---|---|---|
| Wood | 0.47 | 2.13 |
| Recycled HDPE (rHDPE) | 0.94 | 1.06 |
| Recycled LLDPE (rLLDPE) | 0.92 | 1.09 |
| LDPE | 0.926-0.936 | 1.07-1.08 |
| Gypsum | 2.5 | 0.40 |
| Citric Acid | 1.66 | N/A |

As shown in Table 1, when compared to wood, HDPE and LLDPE are less rigid, less resistant to impact, and approximately two times as heavy as wood for the same volume. In contrast, gypsum particles are around 5.3 times denser than wood and around 2.7 times denser than HDPE and/or LLDPE. Accordingly, the rigidity of the HDPE and/or LLDPE can be increased by adding a gypsum reinforcement.

In some embodiment, a dye can be added to the composite mixture to modify/adjust/change the color of the building material product.

Bound water within the gypsum reinforcement can cause issues with extrusion if at a high enough quantity. If enough of the bound water is not released prior to or during the compounding step, unwanted foaming can occur during extrusion of the profiles. Accordingly, in some embodiments, the gypsum dehydration reaction that occurs during mixing or compounding at high temperatures can be managed such that the proper amount of water is released from the gypsum.

Gypsum (CaSO₄*2H₂O) dehydrates in two reactions that take place at different temperatures. At a temperature of between about 120° C. and 130° C., gypsum dehydrates to calcium sulfate hemihydrate and water according to the following formula:

CaSO₄*2H₂O→CaSO₄*½H₂O+3/2H₂O

At a temperature of between about 160° C. and 170° C., the calcium sulfate hemihydrate dehydrates to calcium sulfate and water according to the following formula:

CaSO₄*½H₂O→CaSO₄+½H₂O

Based on the molar mass of the chemical elements, bound water can therefore represent up to about 21% wt of the gypsum material.

In some embodiments, to mitigate downstream issues with extrusion, the gypsum can be dried prior to compounding with the plastic polymer. For example, the gypsum can be dried for a predetermined period of time at a high temperature, such as 100° C., to pre-release the water contained in the gypsum. Alternatively, or additionally, the gypsum and the plastic polymer can be compounded using devolatilization methods, such as a devolatilization vent in a twin-screw extruder used for compounding the plastic polymer and the gypsum. Devolatilization can be conducted under a pressure equal to or below atmospheric pressure (i.e., atmospheric pressure or vacuum pressure).

In some embodiments, recycled gypsum can be used as the gypsum component. For example, gypsum isolated from construction debris, such as old drywall removed during demolition or off-cuts of drywall (including wallboard and/or gyprock), household garbage, gypsum waste from manufacturing gypsum products, etc.

### Weight Reduction

### Foamed Composite Material

Reinforcing the HDPE and/or LLDPE with gypsum can increase the overall weight of the composite material, when compared to a composition comprising only the plastic polymer. Therefore, in some embodiments, a foaming agent or a chemical blowing agent can be used to further reduce the weight of the composite material by releasing gas upon thermal decomposition, such as nitrogen gas (N₂), carbon dioxide (CO₂), and/or hydrogen gas (H₂). In some embodiments, the foaming agent can be azodicarbonadmide (ADCA), such as Celogen® AZ130, p,p′Oxybis(benzene) sulfonyl hydrazide (OBSH), p-Toluene sulfonyl hydrazide (TSH), p-Toluene sulfonyl semicarbazide (TSS), dinitrosopenta-methylenetetramine (DNPT), or 5-Phenyltetrazole (5PT), which produce N₂. In other embodiments, the foaming agent can be sodium bicarbonate or citric acid, which produce CO₂, or sodium borohydride (SBH), which produces H₂. In an exemplary embodiment, the foaming agent can be a blend of sodium bicarbonate and citric acid, such as Reedy SAFOAM®. In some embodiments, the foaming agent can be an endothermic foaming agent, such as citric acid or sodium bicarbonate. Properties of exemplary foaming agents, such as decomposition temperature and gas evolution, can be found below in Table 2.

TABLE 2

| | Endothermic | Decomposition | Gas | Main |
|---|---|---|---|---|
| Foaming | or | Temperature | Evolution | Foaming Gas |
| Agent | Exothermic | (° C.) | (cc/gm) | Evolved |
| Citric | Endothermic | 160 to 210 | 120 | CO₂ |
| Acid/Sodium | | | | |
| bicarbonate | | | | |
| ADCA | Exothermic | 205 to 212 | 220 | N₂ |
| OBSH | Exothermic | 158 to 160 | 125 | N₂ |
| TSH | Exothermic | 110 to 120 | 115 | N₂ |
| TSS | Exothermic | 228 to 235 | 140 | N₂ |
| DNPT | Exothermic | 190 | 190 | N₂ |
| 5PT | Exothermic | 240 to 250 | 220 | N₂ |
| SBH | Endothermic | Activated by | 2000 | H₂ |
| | | exposure to | | |
| | | water | | |

In some embodiments, the composite material can include about 0.2 wt % to about 6 wt % of foaming agent, such as citric acid, sodium bicarbonate, hydrocerol, and the like. For instance, it can include about 0.5 wt % to 5 wt % of citric acid or sodium bicarbonate as the foaming agent, and at least about 0.5 wt % citric acid or sodium bicarbonate. When sodium bicarbonate is used as the foaming agent, a concentration of about 3 wt % to about 6 wt % can be used. In an exemplary embodiment, citric acid is used as the foaming agent, as the required concentration is six times lower than sodium bicarbonate and sodium bicarbonate has some hygroscopic properties, which can make storing and handing the material more difficult.

The choice and the concentration of the foaming agent can vary in accordance with the thermoplastics contained in the composite material. When the plastic polymer includes only LLDPE, the foaming properties of citric acid can be reduced when compared to HDPE. When the plastic polymer includes a ratio of LLDPE to HDPE of 75/25 w/w, the overall weight can be reduced by about 12% when compared to a composite material that has a plastic polymer that includes 100% LLDPE. In some embodiments, when citric acid is used as the foaming agent, the plastic polymer can include at least 25 wt % HDPE to increase the resulting foaming properties.

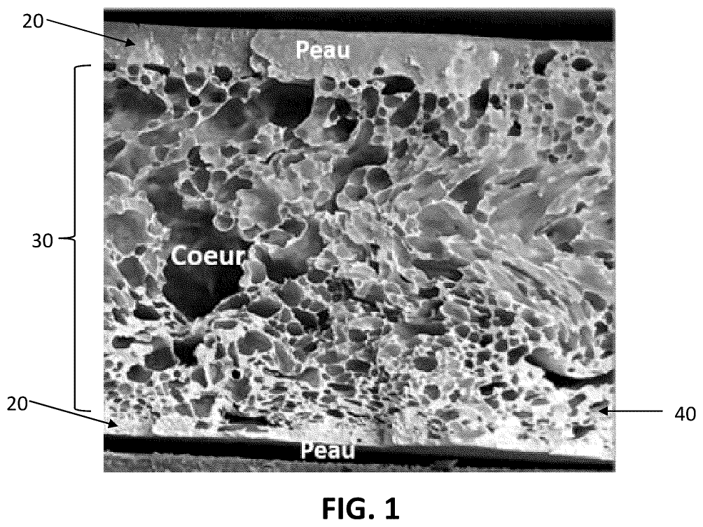

Referring now to FIG. 1, a foamed building material product 10 made from the composite material that includes a compact skin layer 20 and a foamed core 30, inside the skin layer 20, is shown. The foamed core 30 includes pores 40. The ratio of compact skin layer 20 to foamed core 30 decreases when the size of the pores 40 increases. Increased pore size can increase the thickness of the compact skin layer 20.

### Internal Cavities

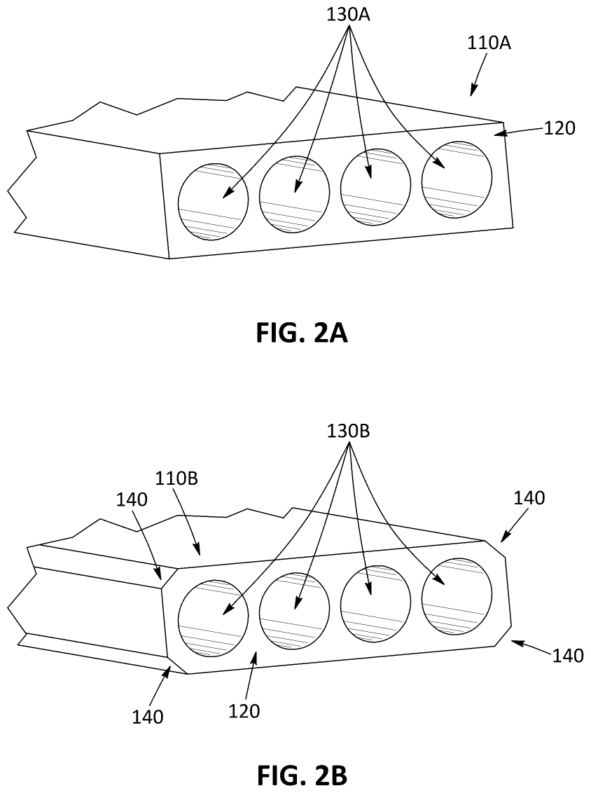

Referring now to FIGS. 2A and 2B, a building material product 110A and 110B made from a composite material 120 is shown with longitudinally-extending internal cavities 130A and 130B, respectively. The building material product 110A and 110B is an elongated product, such as a slat, board, or plank, having a longitudinal axis and the internal cavities 130A and 130B extend along the longitudinal axis. The building material products 110A and 110B were produced by extruding a heated composite material 120 comprising 50/50 w/w plastic polymer to gypsum and the plastic polymer comprised LLDPE and HDPE at a ratio of 75/25 w/w into an elongated rectangular shape. The cavities 130A and 130B extend longitudinally through the building material product 110A and 110B, respectfully. In an embodiment, the internal cavities 120 are formed during the extrusion process of the building material product. For example, the composite material 120 can be injected into a mold that forms building material product 110A and/or 110B with the cavities 130A and 130B, respectively. For example, to produce a building material product 110A and/or 110B that is a replacement for a 12 foot long 2″×4″ (i.e., an elongated rectangle that is 2 inches by 4 inches by 12 feet), the composite material 120 can be extruded into the 2″×4″ shape with internal cavities 120 that extend longitudinally through the material (i.e., through the material length-wise, making the cavities 12 feet long).

The size of the cavities 130A and 130B can vary depending on the size, the shape, and the desired mechanical properties of the building material product 110A and/or 110B. In some embodiments, the cavities 130A and 130B can have a diameter that is between about 10% and about 75% of the thickness of the building material product 110A and/or 110B, or between about 50% and about 70%. In an exemplary embodiment, the building material product 110A or 110B can have a thickness of about 1 inch and a width of about 3 inches. In some embodiment, the building material product 110A or 110B can have a thickness of about ⅝ of an inch to about ¾ of an inch.

In FIGS. 2A and 2B, each one of the composite materials 120 includes four cavities 130A and 130B of a substantially circular cross-section. It is appreciated that, in alternative embodiments (not shown), the number, the shape, and the configuration of the cavities can differ from the embodiments shown.

### Chamfered or Fillet Edges

Referring still to FIGS. 2A and 2B, the weight of the building material product 110A comprising the composite material 120 was further reduced by chamfering or filleting the edges 140 to provide a wood-like profile, as shown in FIG. 2B. By chamfering the edges 140, the overall weight of the building material product 110B can be reduced. In some instances, chamfering or filleting the building material product 110B can reduce the weight by 5% to 15%. In the exemplary embodiment shown in FIG. 2B, chamfering the edges reduced the overall weight of the sample by 10.6 g or about 5%.

### Inclusion of Fillers

In some embodiments, a portion of the composite material can be a non-gypsum filler. For example, wood flour, cardboard, or saw dust can be added to the composite mixture to reinforce and/or reduce the weight of the formed product by reducing the concentration of gypsum. In some embodiments, the composite material includes up to 25% wt filler, or in some embodiments, not more than 15% wt filler.

### Methods of Producing the Building Materials

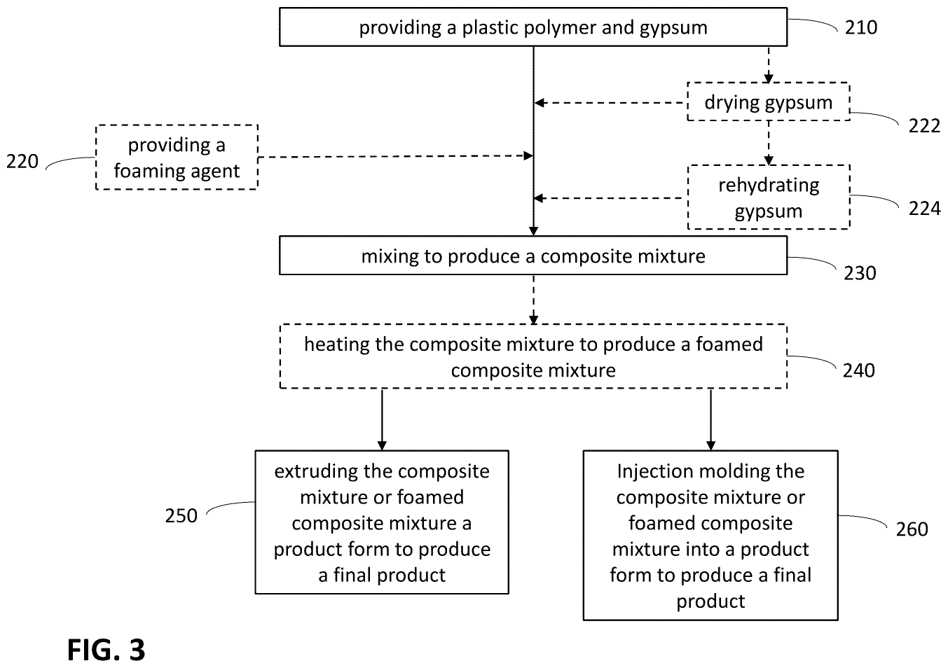

The composite material described herein can be used as a building material, such as dimensional lumber, plywood, wooden slats, or nail strip replacement. Referring now to FIG. 3, a method of producing the building material includes: providing at least 40 wt % plastic polymer (which can be a mixture of plastic polymers of different compositions) and up to 45 wt % gypsum (step 210). In some embodiments, a foaming agent can be included with the plastic polymer and gypsum (step 220). In some embodiments, the gypsum can be dried (step 222). Drying can include, for example, heating the non-dried gypsum at 200° C. for 40 hours or another suitable temperature and period of time to reduce the moisture content of the gypsum, as detailed above. In some embodiments, the raw gypsum or the dried gypsum can be rehydrated to an adequate moisture level (step 224) prior to be mixing with the plastic polymers. In some embodiments, the adequate moisture level of gypsum can range between about 3 wt % and about 20 wt %.

In some embodiments, the composite material includes at least 40 wt % of gypsum in another embodiment, at least 35 wt % of gypsum.

The plastic polymer, gypsum, and optionally, a foaming agent, are then mixed together by known mixing means to produce a homogenous or substantially homogenous composite mixture (step 230), which can also be referred to as compounding. During the compounding step, the mixture can be heated at least to the plastic polymer melting point. In some embodiments, the plastic polymer and the gypsum are compounded using a screw extruder, such as a twin screw extruder. In some embodiments, the screw extruder includes at least one devolatilization zone to remove excess water from the gypsum. The devolatilization zones are configured to remove the maximum amount of water released by the gypsum during extrusion and can be a vacuum devolatilization zone and/or at atmospheric pressure.

When the composite material includes a foaming agent, the composite mixture can be heated such that gas from the foaming agent is released, causing the composite mixture to foam (step 240). In some embodiments, the composite mixture can be heated to between 110° C. and 250° C., depending on the type of foaming agent used. In other embodiments, the foaming agent can be activated to release gas when the composite mixture is heated during the extrusion process.

In some embodiments, the foamed or non-foamed composite mixture can then be extruded into a shape suitable as a building material, such as, without limitation, an elongated rectangular shape, such as a dimensional lumber form, or a sheet form to produce a final product, such as a building material (step 250). The shape of the final product can include internal cavities and/or beveled, filleted, or chamfered edges. In some embodiments, the foamed or non-foamed composite mixture can be injection molded into a suitable form to form a final product (step 260). For example, a single screw extruder can be used to extrude the compounded mixture into a suitable mold. In some embodiments, the mold can include cavities and/or chamfered, beveled, or filleted edges. In some embodiments, the final product can resemble a building material, such as dimensional lumber or sheet wood, such as plywood or OSB sheets.

It is understood that the final product can be any shape suitable for extrusion or injection molding, and is not limited to building materials. For example, the composite material can be extruded to form a building material product having a thickness of between ½ inch and 8 inches and a width of between ½ inch and 8 inches. Accordingly, the composite material can be extruded or injection molded to form a building material product that mimics dimensional lumber, such as 12 foot boards that have a dimensional of, without limitation, 1×2, 1×3, 1×4, 2×4, 2×6, 2×8, 2×10, 4×4, 6×6, 10×10, etc. In these examples, the internal cavities can extend the entire 12 feet, or only a portion thereof. In some embodiments, the internal cavities can extend longitudinally through a portion of the elongated shape, such that the ends of the elongated shape are closed.

In other embodiments, the composite material can be extruded or injection molded into a sheet form to produce a building material sheet, such as a building material replacement for plywood or OSB sheets. In these embodiments, the composite material can be extruded or injection molded into a sheet form having a thickness of between ¼ inch and 1 inch. The size of the sheet form can be any range, such as the standard 4 feet by 8 feet, or any other size, such as 7 feet by 3 feet (resembling marine plywood) or 6 feet by 4 feet. In other embodiments, the composite material can be extruded or injection molded into any form, such as a specific size and shape for a specific building project.

In some embodiments, the mixing (compounding) and extrusion steps (steps 230 and 250) can be performed as a single step since mixing occurs via the extruder screw. In some embodiments, the heating and extrusion steps (steps 240 and 250) can be performed as a single step since some extruders are heated extruders. Consequently, in some embodiments, the mixing (compounding), heating and extrusion steps (steps 230, 240, and 250) can be performed as a single step.

In some embodiments, the plastic polymer can be supplied as pellets to the mixing step or the extrusion step. In other embodiments, the plastic polymer can be supplied as shreds or particles.

In some embodiments, the gypsum, including optionally the filler, is also supplied as particles/powder. For instance, gypsum panels (or portions thereof) can be comminuted, such as by grinding, before being introduced in the mixing step or the extrusion step.

### Examples and Experimental Data

### Example 1

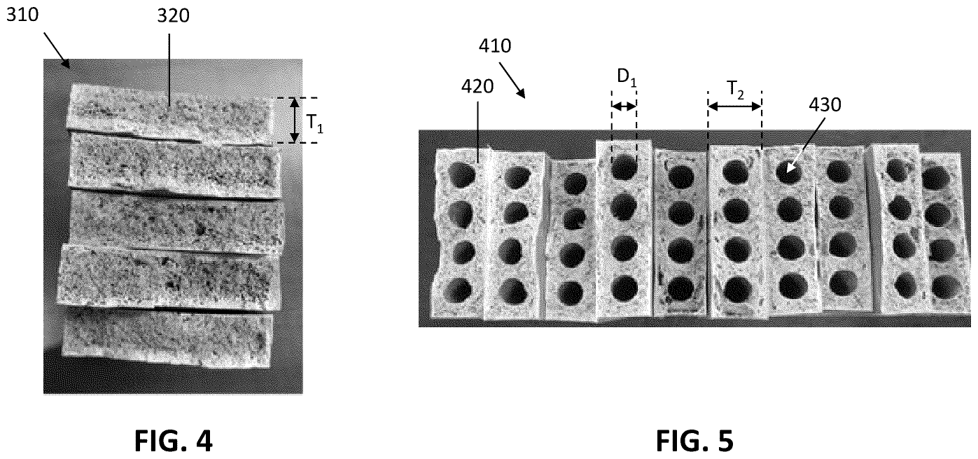

Referring now to FIG. 4, five exemplary building material products 310 made of a composite material 320 that comprises about 66% w/w HDPE and about 33% w/w gypsum is shown. The building material products 310 were foamed with a foaming agent (0.5 wt % citric acid) and extruded into an elongated form that resulted in the building material products 310 having a thickness T₁ of ⅝ of an inch, a width of 2.5 inches, and a length of 12 inches. Of the five building material products 310, the average weight of the samples was 170.52 g.

### Example 2

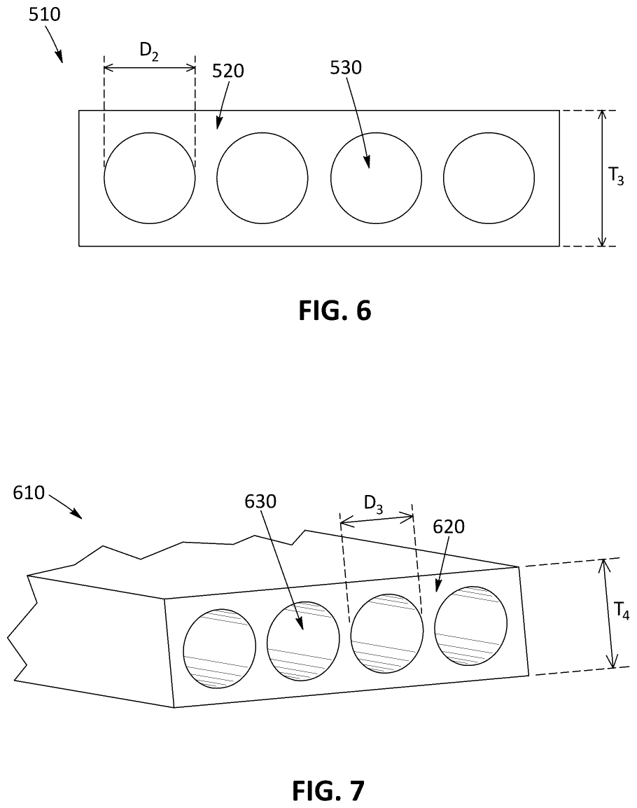

Referring now to FIG. 5, ten exemplary building material products 410 made of a composite material 420 that comprises about 66% w/w HDPE and 33% w/w gypsum is shown. The building materials products 410 were foamed with a foaming agent (3 wt % citric acid) and extruded into an elongated form that resulted in the building material products 410 having a thickness T₂ of ¾ of an inch thick. Each one of the building material products 410 has four elongated cavities 430 that extend longitudinally through the middle of the building material products 410. The cavities 430 have a diameter D₁ of ⅜ of an inch. Of the ten building material products 410, the average weight of the samples was 169.27 g.

### Example 3

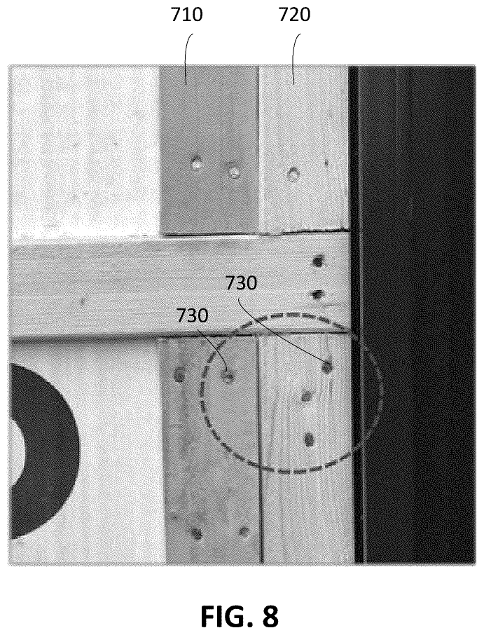

Referring now to FIG. 6, an exemplary building material product 510 made of a composite material 520 that comprises about 66% w/w plastic polymer that included about 75% LLDPE and about 25% HDPE (i.e., about 49.5% LLDPE and about 16.5% HDPE) and about 33% w/w gypsum is shown. The building material product 510 was foamed with a foaming agent (3 wt % citric acid) and extruded into an elongated form that resulted in the building material product 510 having a thickness T₃ of 23/32 of an inch. The building material product 510 has elongated cavities 530 extending longitudinally through the middle of the building material product 510. The cavities 530 have a diameter D₂ of 7/16 of an inch. The building material product 510 had an average weight of 208.80 g.

### Example 4

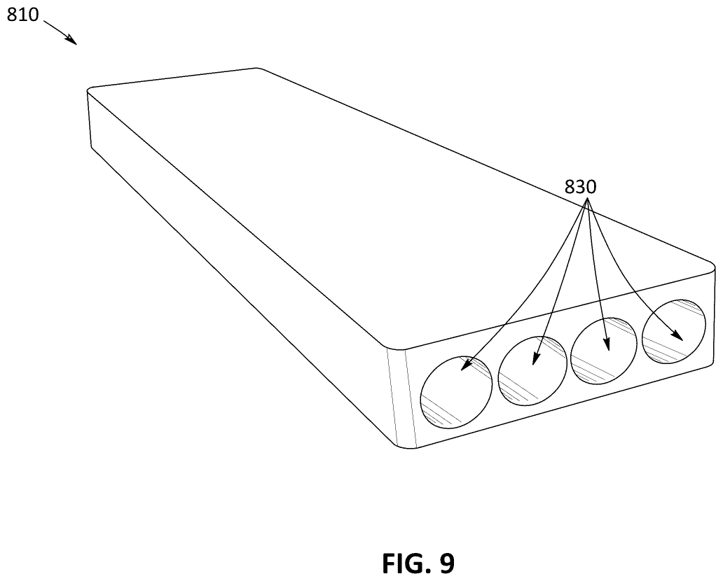

Referring now to FIG. 7, an exemplary building material product 610 made of a composite material 620 that comprises about 66% w/w plastic polymer that included about 75 wt % LLDPE and about 25 wt % HDPE (i.e., about 49.5 wt % LLDPE and about 16.5 wt % HDPE) and about 33% w/w gypsum is shown. The composite material 620 has the same composition than the composite material 520, solely the size of the cavities 530, 630 of the two building material products 510, 610 differs. The building materials product 610 was foamed with a foaming agent (3 wt % citric acid) and extruded into an elongated form that resulted in the building material product 610 having a thickness T₄ of 23/32 of an inch. The building materials product 610 has elongated cavities 430 extending longitudinally through the middle of the building material product 610. The cavities 630 have a diameter D₃ of ½ an inch. The building material product 610 had an average weight of 184.73 g.

As can be seen from Table 3, each of examples 1 to 4 are significantly lighter than a similar volume of wood plastic composite (WPC).

TABLE 3

| | | | Plastic | | | | | |
|---|---|---|---|---|---|---|---|---|
| | | | polymer | | Plastic | | Cavity size | |
| | | | Ratio | | polymer/ | | (inches) | Avg. |
| | LLDPE | HDPE | (LLDPE/ | Gypsum | Gypsum | Thickness | [percentage | Weight |
| No. | (% w/w) | (% w/w) | HDPE) | (% w/w) | Ratio | (inches) | of thickness] | (g) |
| 1 | 0 | 66 | 0/100 | 33 | 66/33 | 5/8 | N/A | 170.52 |
| 2 | 0 | 66 | 0/100 | 33 | 66/33 | 3/4 | 3/8 [50%] | 169.27 |
| 3 | 49.5 | 16.5 | 75/25 | 33 | 66/33 | 23/32 | 7/16 [61%] | 208.80 |
| 4 | 49.5 | 16.5 | 75/25 | 33 | 66/33 | 23/32 | 1/2 [70%] | 184.73 |
| WPC | N/A | N/A | N/A | N/A | N/A | 19/32 | N/A | 280.00 |
| Wood | N/A | N/A | N/A | N/A | N/A | 23/32 | N/A | 138.44 |
| (SPF) | | | | | | | | |

### Experimental Data for Examples 1 to 4

### Composite Material Properties

Each of examples 1 to 4 were tested with the American Society for Testing and Materials (ASTM) Standard Test Methods for Flexural Properties of Unreinforced and Reinforced Plastics and Electrical Insulating Materials (ASTM D790). As a comparison to other building materials, non-foamed wood-plastic composite (WPC) (TREX™) and spruce, pine, fir (SPF) stud lumber wood were also tested.

TABLE 4

| | | Break- | | Max | | |
|---|---|---|---|---|---|---|
| | Flexural | ing | Tensile | defor- | | Density |
| | Modulus | Force | strength | mation | Density | (mate- |
| No. | (psi) | (lbs) | (psi) | (%) | (overall) | rial) |
| 1 | 154,252 | 216 | 2623 | 4.07% | 0.685 | 0.685 |
| 2 | 164,465 | 231 | 2311 | 2.36% | 0.567 | 0.848 |
| 3 | 99,834 | 220 | No | 13% | 0.712 | 1.160 |
| | | | Break | | | |
| 4 | 88,292 | 200 | No | 13% | 0.630 | 1.124 |
| | | | Break | | | |
| WPC | 450,868 | 283 | 3499 | 1.47% | 1.182 | 1.182 |
| Wood | 230,260 | | 1711 | 1.55% | 0.470 | 0.470 |
| (SPF) | | | | | | |

As shown in Table 4, when the plastic polymer portion of the composite material included a combined matrix of LLDPE and HDPE at a ratio of 75 to 25 that is foamed and includes internal cavities, the modulus of elasticity or the flexural modulus was reduced by about 40% (example 3) or 46% (example 4) when compared to a composite material that included 100% HDPE plastic polymer that is foamed and includes internal cavities (example 2). Despite the reduction of the flexural modulus when a combined matrix of LLDPE and HDPE is used as the plastic polymer, when 7/16 inch cavities were included (example 3), the breaking force (220 lb) was comparable to the breaking force when the plastic polymer included 100% HDPE with % inch cavities (example 2), which had a breaking force of 231 lbs, or when the plastic polymer included 100% HDPE without cavities (example 1), which had a breaking force of 216 lbs. Interestingly, when the plastic polymer included a combined matrix of LLDPE and HDPE and ½ inch cavities were included (example 4), the breaking force decreased to 200 lbs.

As can be seen in Table 4, the overall density of all examples 1 to 4 was significantly less than the density of conventional non-foamed WPC, yet slightly more dense than SPF wood. The material density for examples 2 to 4 is closer to the density of the non-foamed WPC; however, the addition of cavities in the building material resulted in a lower overall density for examples 2 to 4, when compared to non-foamed WPC. Indeed, examples 3 and 4, which have a plastic polymer that includes both LLDPE and HDPE, has a similar material density to WPC. As can be seen, both the material density and the overall density of all examples 1 to 4 are higher than the density of SPF wood.

When the plastic polymer portion of the composite material includes a combined matrix of LLDPE and HDPE at a ratio of 75 to 25 w/w that is foamed and includes internal cavities (examples 3 and 4), the composite material did not break when tested under ASTM D790 conditions, regardless of the diameter of the cavities (i.e., cavities that are 7/16 of an inch for example 3 and ½ an inch for example 4). In contrast, when the plastic polymer portion of the composite material included only HDPE and is foamed (example 1) or foamed and includes internal cavities (example 2), the samples broke at 2623 psi and 2311 psi, respectively.

### Examples 5 to 8

Composite materials that included a plastic polymer containing 100% LLDPE in a ratio with gypsum of 70/30 w/w (examples 5 and 6) and 60/40 w/w (examples 7 and 8), were tested when mixed with 3% w/w sodium bicarbonate (NaHCO₃) to provide foamed examples 6 and 8 and compared to non-foamed examples 5 and 7.

TABLE 5

| | Ratio | | | | | |
|---|---|---|---|---|---|---|
| | LLDPE/ | | | Cavity | | Density |
| | Gypsum | NaHCO₃ | Weight | Volume | Density | Reduction |
| No. | (% w/w) | (% w/w) | (g) | (cm³) | (g/cm³) | (%) |
| 5 | 70/30 | 0 | 247 | 256 | 0.965 | 11% |
| 6 | 70/30 | 3 | 221 | 256 | 0.863 | |
| 7 | 60/40 | 0 | 267 | 256 | 1.043 | 19% |
| 8 | 60/40 | 3 | 215 | 256 | 0.840 | |

As can be seen in Table 5, when the ratio of LLDPE to gypsum increased from 60/40 to 70/30 (% w/w), the foamed building material product saw a decrease in the density reduction of the final product from 19% to 11%. However, due to the higher density of gypsum, the overall density of the foamed composite material for examples 6 and 8 was very similar (0.863 g/cm 3 and 0.840 g/cm 3, respectively).

### Example 9

A composite material that included about 66% w/w HDPE, about 33% w/w gypsum, and 0.5% w/w citric acid (example 9) was foamed to produce a sample with a weight of 170.50 grams, which is significantly less than examples 5 to 8, which used sodium bicarbonate as the foaming agent at a concentration six times greater than the 0.5% w/w concentration of citric acid used in example 9. These results indicate that HDPE has increased foaming properties when compared with LLDPE and that when the plastic polymer is primarily LLDPE, the LLDPE matrix foams significantly less with citric acid than with sodium bicarbonate as the foaming agent.

### Example 10

A composite material that included a plastic polymer that contained LLDPE and HDPE in a ratio of 75 to 25 (% w/w) and a citric acid foaming agent, resulted in a weight reduction of around 12% when compared to a composite material that included a plastic polymer containing 100 wt % LLDPE.

### Examples 11 to 16

Examples 11 to 16 are summarized below in Table 6.

TABLE 6

| | | | Plastic | | | | |
|---|---|---|---|---|---|---|---|
| | | | polymer | Gyp- | Plastic | Citric | Aver- |
| | LLDPE | HDPE | Ratio | sum | polymer/ | Acid | age |
| | (% | (% | (LLDPE/ | (% | Gypsum | (% | Weight |
| No. | w/w) | w/w) | HDPE) | w/w) | Ratio | w/w) | (g) |
| 11 | 49.5 | — | 100/0 | 49.5 | 50/50 | 0.5 | 247 |
| 12 | 56 | — | 100/0 | 43 | 56/43 | 0.5 | 236 |
| 13 | 66 | — | 100/0 | 33 | 66/33 | 0.5 | 226 |
| 14 | 37.5 | 12.5 | 75/25 | 50 | 50/50 | 0.5 | |
| 15 | 42 | 14 | 75/25 | 43 | 56/43 | 0.5 | |
| 16 | 49.5 | 16.5 | 75/25 | 33 | 66/33 | 0.5 | |

TABLE 7

| | | | | | | Est. |
|---|---|---|---|---|---|---|
| | | | | Overall | Material | Weight |
| | Thickness | Cavities | Average | Density | Density | 12 ft board |
| No. | (inches) | (inches) | Weight (g) | (g/cm³) | (g/cm³) | (kg/lbs) |
| 1 | 5/8 | N/A | 170.52 | 0.865 | 0.685 | 2.90/6.39 |
| 2 | 3/4 | 3/8 | 169.27 | 0.848 | 9.848 | 2.41/5.29 |
| 3 | 23/32 | 7/16 | 208.80 | 1.160 | 1.160 | 3.02/6.65 |
| 4 | 23/32 | 1/2 | 184.73 | 1.124 | 1.124 | 2.67/5.88 |
| 11 | 23/32 | 3/8 | 247 | 1.260 | 1.260 | 3.56/7.82 |
| 12 | 23/32 | 3/8 | 236 | 1.204 | 1.204 | 3.40/7.47 |
| 13 | 23/32 | 3/8 | 226 | 1.153 | 1.153 | 3.25/7.16 |
| 14 | 23/32 | 1/2 | 210 | 1.278 | 1.278 | 3.04/6.68 |
| 15 | 23/32 | 1/2 | 197.39 | 1.201 | 1.201 | 2.86/6.28 |
| WPC | 19/32 | N/A | 280 | 1.182 | 1.182 | 5.01/11.03 |
| Wood | 43/64 | N/a | 103 | 0.391 | 0.391 | 1.66/3.65 |
| (Spruce) | | | | | | |

### Testing Under Typical Use Conditions

### Nail Penetration Test

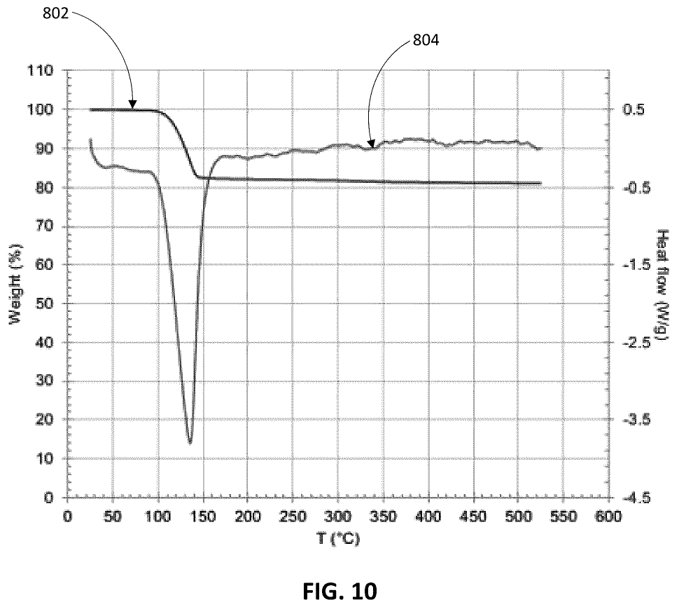

As shown in FIG. 8, a building material product 710 comprising a composite material as defined herein and a counterpart wood building material 720 is shown. The building material product 710 and the counterpart wood building material 720 underwent a nail penetration and retention test, where nails 730 were inserted into the building material product 710 and the counterpart wood building material 720. As can be seen, the building material product 710 had comparable, and even improved, nail penetration and retention to the counterpart wood building material 720. Unlike wood products, which often contain knots that have different fibre distortions around the knot, the building material product 710 did not show signs of splitting during the nail penetration test.

### Sawing Test

The building material products were subjected to a sawing test (i.e., subjected to rapid motion by a toothed or cutting tool (a saw) to divide the building material product into two pieces). The building material products showed comparable sawing proficiency to wood products. No significant differences were observed between building products comprising HDPE, LLDPE, or a ratio of LLDPE/HDPE.

### Additional Compositions

### Example 17

A composite material that included 39% w/w LLDPE, 59% w/w gypsum, and 2% w/w mineral wool was mixed and extruded into an elongated, rectangular sample. Bending tests were conducted on the samples, which caused breakage of the fragile material.

### Example 18

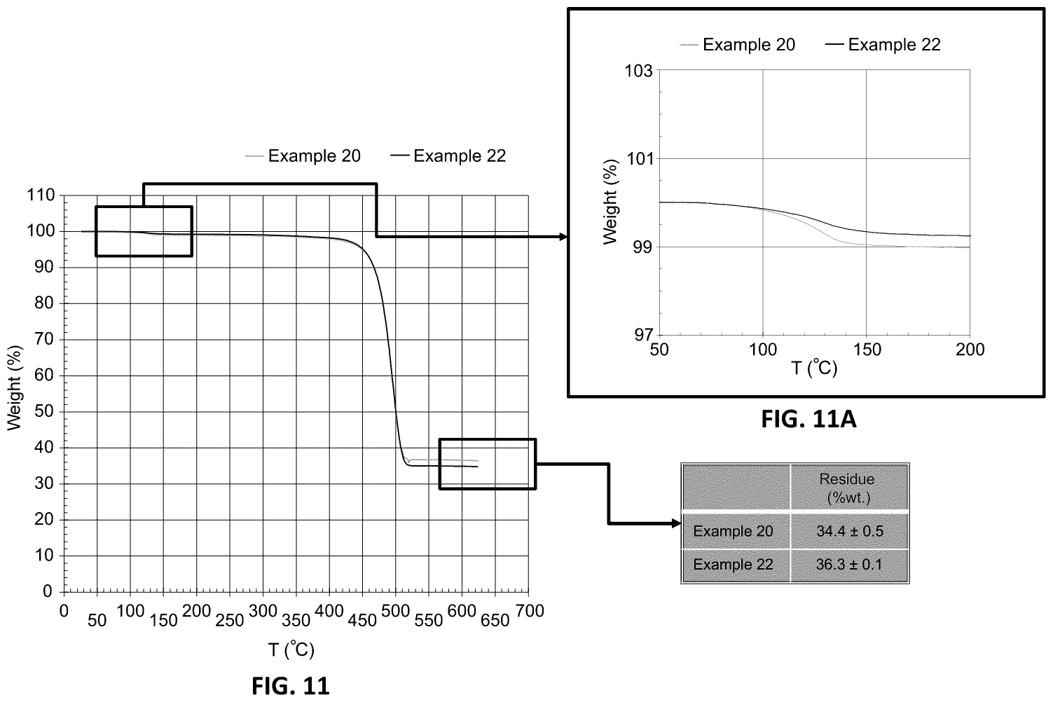

Referring now to FIG. 9, a building material product 810 comprising a composite material that included 67% w/w plastic polymer containing 90% w/w LLDPE and 10% w/w ABS and 33% w/w gypsum is shown. A foaming agent was not included in the composite mixture, and thus the building material product 810 is not foamed. The building material product 810 includes cavities 830 and had a thickness of 7/16 inches.

### Examples 19 to 22

Further examples of composite mixtures of 60-70% wt LDPE and 30-40% wt gypsum were made. The composite materials of examples 19 to 22 are summarized below in Table 8.

TABLE 8

| | LDPE % w/w | Gypsum % w/w | Type of | Compounding |
|---|---|---|---|---|
| No. | (kg) | (kg) | Gypsum | (total weight) |
| 19 | 70% | 30% | Non-dried | 10 kg |
| | (7 kg) | (3 kg) | | |
| 20 | 65% | 35% | Non-dried | 20 kg |
| | (13 kg) | (7 kg) | | |
| 21 | 60% | 40% | Non-dried | 20 kg |
| | (12 kg) | (8 kg) | | |
| 22 | 65% | 35% | Dried | 20 kg |
| | (13 kg) | (7 kg) | | |

### Materials

As can be seen, none of examples 19 to 22 contained a foaming agent, and thus the formed product is a non-foamed product.

The gypsum in examples 19 to 21 were provided as non-dried gypsum (raw gypsum that has not undergone a drying step) that had been recycled. A moisture content was analyzed using a thermogravimetric moisture analyzer (Sartorius™) for 15 minutes at 200° C. The moisture content of the non-dried gypsum was between about 18% wt and 22% wt, with the average moisture content of the non-dried gypsum being 18.28% wt water.

The gypsum in example 22 was obtained from the same non-dried recycled gypsum and was subjected to a drying step. The drying step included drying the gypsum for 40 hours at 100° C. A moisture content of the dried gypsum was analyzed using a thermogravimetric moisture analyzer (Sartorius™) for 15 minutes at 200° C. The average moisture content of the dried gypsum was 4.74% moisture.

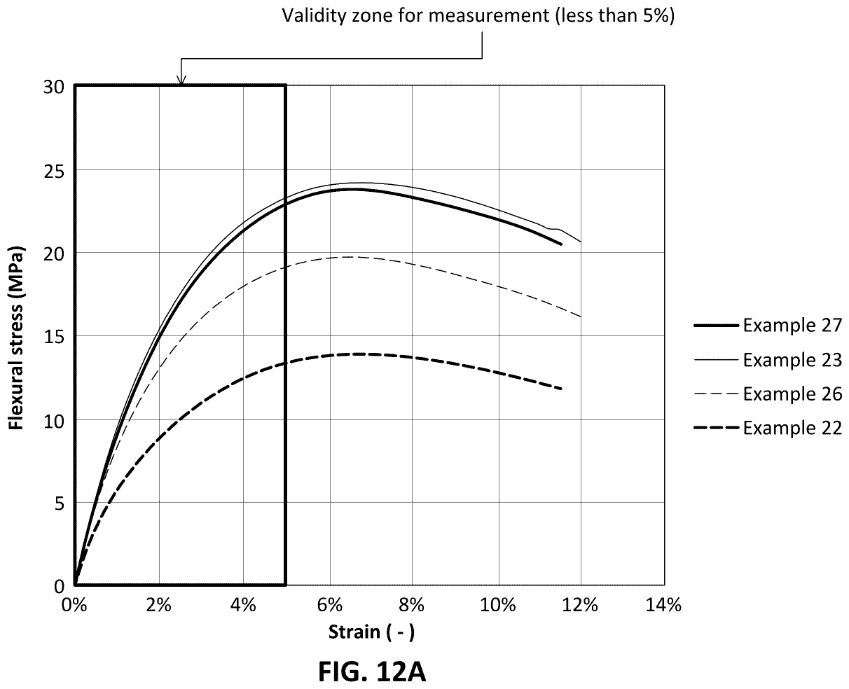

Referring now to FIG. 10, a thermogravimetric analysis (TGA) 802 was conducted on the non-dried recycled gypsum 802 using a Mettler Toledo™ TGA1. The TGA determined the change of mass (weight %) as a function of temperature (° C.). The measurements were conducted in a nitrogen (N₂) environment at a heating rate of 10° C./min on about 5 mg samples of non-dried gypsum.

As can be seen from FIG. 10, the non-dried gypsum showed about an 18% wt loss of mass between 100° C. and 200° C., which was consistent with the moisture testing conducted with the thermogravimetric moisture analyzer. The differential thermal analysis (DTA) curve 804 was recorded with the Mettler Toledo™ TGA1. The DTA curve 804 shows that the 18% loss of mass is related to an endothermic reaction, which is consistent with a dehydration reaction and an evaporation reaction.

### Compounding Step

A Leistritz™ 34 mm co-rotating twin-screw extruder with two (2) devolatilization zones was used to compound the LDPE and the gypsum for examples 19 to 22. The twin-screw extruder included 12 zones, with zone 1 being the intake zone, zone 5 was a vacuum zone with a devolatilization port that used vacuum pressure to remove excess water, and zone 9 was a vent zone with a devolatilization port at atmospheric pressure (1 atm). The twin-screw extruder compounded the LDPE and the gypsum while removing excess moisture therein. An air-cooling mat and a granulator were used on the extruded product to create LDPE/gypsum compounded granules (or extrudate) that can be used in the extruder.

During the compounding step, the non-dried gypsum released about 18% wt, which is contributed to the bound water and is consistent with the thermogravimetric analysis shown in FIG. 10. It was observed that the vacuum devolatilization port or vent in zone 4 was particularly effective in removing the water released from the non-dried gypsum.

During the compounding step, the dried gypsum released about 5% wt.

It was observed that up to 40% w/w of non-dried gypsum can be included in the composition with the plastic polymer without observing bridging in the hopper due to moisture return.

It was observed that the extrudate produced with non-dried gypsum showed physical indications of foaming during the compounding step, without addition of a foaming agent. It is theorized that the foaming is caused by the water being released during the gypsum dehydration reaction.

### Extrusion

The pellets of examples 19 to 22 were extruded using a single screw extruder (1.5-inch Flag single-screw extruder using a die and conformer). The compositions of examples 19 and 22 were extruded using a die having a building material profile to create a formed product. The formed product was cooled using a water-cooling bath and an extrusion puller. The temperatures were adjusted to the melting point of the LDPE, which is about 115° C.

It was observed that examples 19 and 22 resulted in properly extruded products. When extruded, examples 20 and 21 did not form a good profile. It is theorized that the extrusion was unsuccessful due to foaming, which may have occurred from the presence of residual water in the granules that were not removed during the compounding step or from a continuation of the gypsum dehydration reaction during the extrusion step. It is also possible that the improper formation of the extruded samples could be caused by improper vacuum pressure that affected the shape of the extruded product, i.e. shrinkage occurred.

### Injection Molding

The compounded extrudate of examples 20 and 22 were injection molded using a 34-ton Boy injection press using a mold to produce standard samples for measuring mechanical properties. As the extrudate is highly viscous, the injection press was operated at a high temperature for LDPE (about 220° C. to 240° C.). The injected samples for examples 20 and 22 did not show significant shrinkage and thus it is theorized that residual water in the extrudate is not problematic for injection molding. It was observed that the injection molded samples observed a strong smell that is theorized to result from recycled materials being injected at a high temperature.

### TGA Analysis—Polymers

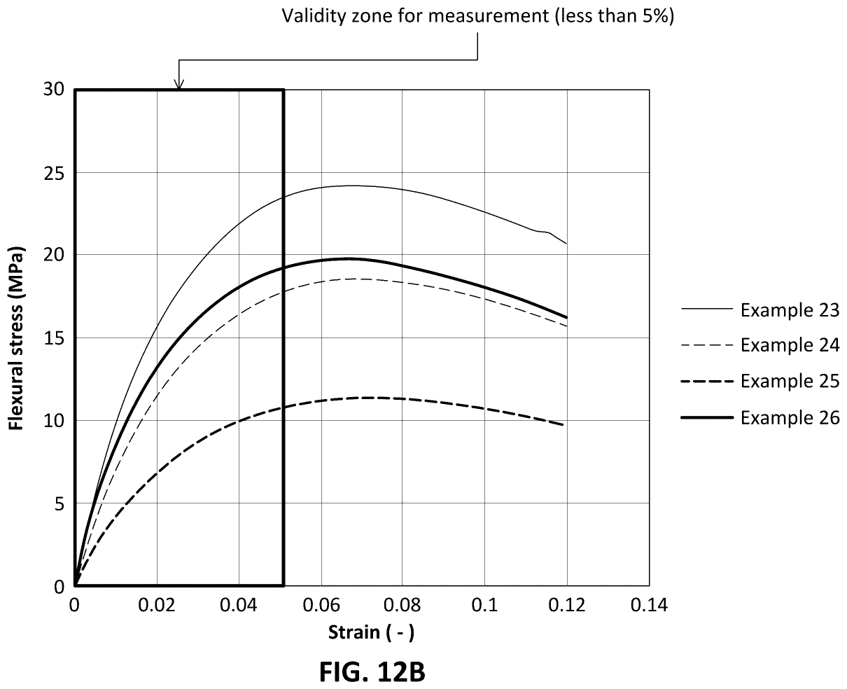

The true mineral content in examples 20 and 22 were determined by testing 2 samples of each using a Mettle Toledo™ TGA1. Measurements were taken in a nitrogen (N₂) environment at a heating rate of 20° C./min on about 5 mg samples. As shown in FIGS. 11 and 11A, the test confirmed that examples 20 and 22 included 34.4±0.5% wt and 36.3±0.1% wt minerals, respectively. Example 20 showed a slightly greater (about 0.2% wt) loss in mass between 100° C. and 200° C. than example 22. It is contemplated that the higher loss of mass may cause the foaming observed during the extrusion of example 20.

### Examples 23 to 26

Further examples of composite mixtures of 70-80% wt HDPE/LDPE and 20-30% wt reinforcement were made. The reinforcement comprised of 85% wt gypsum and 15% wt wood flour. The composites of examples 23 to 26 are summarized below in Table 9.

TABLE 9

| | Polymer % w/w | Reinforcement % w/w | |
|---|---|---|---|
| No. | (HDPE:LDPE ratio) | (Gypsum:Wood Flour) | Foamed |
| 23 | 80% | 20% | No |
| | (70:30) | (85:15) | |
| 24 | 80% | 20% | No |
| | (30:70) | (85:15) | |
| 25 | 80% | 20% | Yes |
| | (30:70) | (85:15) | |
| 26 | 70% | 30% | No |
| | (30:70) | (85:15) | |
| 27 | 80% | 20% | Yes |
| | (70:30) | (100:0) | |

Example 25 further included 2% wt Hydrocerol™ 1514 as the foaming agent.

### Density

Density tests were conducted on examples 22 to 26 using an Alfa Mirage electronic density meter. 100 mm length samples were cut from extruded profiles and 3 samples were tested for each exemplary composite material. The results are shown in Table 10.

TABLE 10

| | | | | | Stan- | |
|---|---|---|---|---|---|---|
| | Density (g/cm³) | | | | dard | Theo- |
| | Sample | Sample | Sample | Aver- | Devi- | retical |
| Ex. | 1 | 2 | 3 | age | ation | (g/cm³) |
| 22 | 1.101 | 1.101 | 1.101 | 1.101 | 0.000 | 1.165 |
| 23 | 1.100 | 1.101 | 1.101 | 1.101 | 0.001 | 1.073 |
| 24 | 1.094 | 1.094 | 1.094 | 1.094 | 0.000 | 1.053 |
| 25 | 0.868 | 0.835 | 0.859 | 0.854 | 0.017 | N/A |
| 26 | 1.076 | 1.077 | 1.074 | 1.076 | 0.002 | 1.124 |
| HDPE | | | | | | 0.96- |
| | | | | | | 0.98 |
| LDPE | | | | | | 0.918- |
| | | | | | | 0.930 |
| Gypsum | | | | | | 2.3 |
| Wood | | | | | | 1.5 |
| Flour | | | | | | |

As can be seen from Table 10, the foaming agent (1 wt % Hydrocerol™ 1514) included in example 25 resulted in a loss in density of about 22%. The concentration of foaming agent is given in relation to the amount of the total plastic polymer and gypsum mixture.

### Flexural Modulus

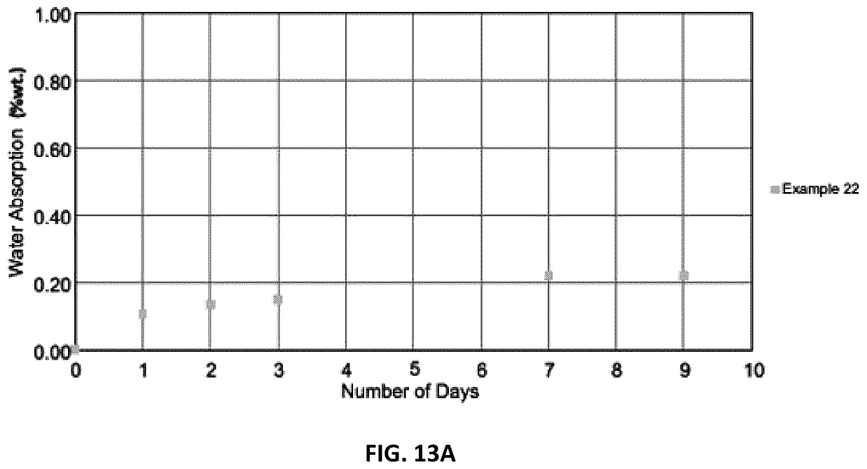

Referring now to FIGS. 12A and 12B, a flexural modulus test was conducted on examples 22 to 26 according to ASTM D790-17 procedure (“Standard Test Methods for Flexural Properties of Unreinforced and Reinforced Plastics and Electrical Insulating Materials”) using an Instron device. The tests were carried out on rectangular samples measuring 210 mm×25 mm×10.75 mm cut from extruded profiles. The span was 172 mm and the strain rate used was 0.10 mm/mm/min and a limit of 5.0% deformation was used (procedure B: non-breaking materials). Before testing, the samples were conditioned for 88 hours in 23° C. and 50% relative humidity (RH) according to ASTM D618-21 procedure (“standard practice for conditioning plastics for testing”, method A (height samples >7 mm)). The results are shown in Table 11.

TABLE 11

| Ex. | Flexural Modulus (MPa) | Flexural Stress at 5% (MPa) |
|---|---|---|
| 22 | 683 ± 20 | 13.3 ± 0.2 |
| 23 | 1100 ± 41 | 23.3 ± 0.3 |
| 24 | 797 ± 57 | 17.7 ± 0.1 |
| 25 | 521 ± 48 | 11.7 ± 0.8 |
| 26 | 990 ± 44 | 19.1 ± 0.1 |

The flexural modulus of HDPE and LDPE alone is about 965 MPa and 245 to 335 MPa. As can be seen, all of examples 22 to 26 have a higher flexural modulus of LDPE alone and examples 23 and 26 have a flexural modulus that is higher than HDPE alone.

### Deflection Temperature Under Load

The deflection temperature under load was measured using the ASTM D648-18 procedure (“Standard Test Method for Deflection Temperature of Plastics Under Flexural Load in the Edgewise Position”) using a CEAST HDT-VICAT Model 6911.000 instrument and a load of 1.82 MPa. The samples were rectangular in shape and measured 130 mm×12.7 mm×12.7 mm cut from the extruded profiles. The span was 120 mm and 3 samples were tested for each exemplary composite material. Before testing, the samples were conditioned for 88 hours at 23° C. and 50% RH according to ASTM D618-21 (“Standard Practice for Conditioning Plastics for Testing”, method A (height samples >7 mm)). The results are shown in Table 12.

TABLE 12

| | | | | | Stan- | |
|---|---|---|---|---|---|---|
| | Deflection temp. at 1.82 MPa (° C.) | | | | dard | Theo- |
| | Sample | Sample | Sample | Aver- | Devi- | retical |
| Ex. | 1 | 2 | 3 | age | ation | (° C.) |
| 22 | 35.7 | 36.5 | 35.7 | 36.0 | 0.5 | |
| 23 | 41.9 | 39.9 | 42.7 | 41.5 | 1.4 | |
| 24 | 37.2 | 36.2 | 37.4 | 36.9 | 0.6 | |
| 25 | 35.3 | 35.0 | 35.4 | 35.2 | 0.2 | |
| 26 | 38.0 | 38.1 | 36.8 | 37.6 | 0.7 | |
| HDPE | | | | | | 45-60 |
| | | | | | | (60-90° C. at |
| | | | | | | 0.455 MPa) |
| LDPE | | | | | | 30-40 |
| | | | | | | (40-50° C. at |
| | | | | | | 0.455 MPa) |

### Melt Flow Index (MFI)

The melt flow index (MFI) is a measure of the viscosity of the material at a given shear rate. The MFI refers to the amount of polymer or composite mixture thereof is extruded through a known given orifice (such as a die) over time. The MFI of examples 22, 23, and 26 were measured according to ASTM 1238 procedure (“Standard Test Method for Melt Flow Rates of Thermoplastics by Extrusion Plastometer”) using an XNR-400 TMI instrument. The measurements were carried out at 190° C. under a load of 2.16 kg. Two measurements were taken for each exemplary composite material. The results are in Table 13.

TABLE 13

| Ex. | MFI (g/10 min) | Theoretical (g/10 min) |
|---|---|---|
| 22 | 0.37 ± 0.01 | |
| 23 | 0.23 ± 0.01 | |
| 26 | 1.47 ± 0.01 | |
| HDPE | | 0.2-0.5 |
| LDPE | | 05-2.0 |

The low fluidity (high viscosity) grades are suitable for the extrusion process.

### Moisture Absorption

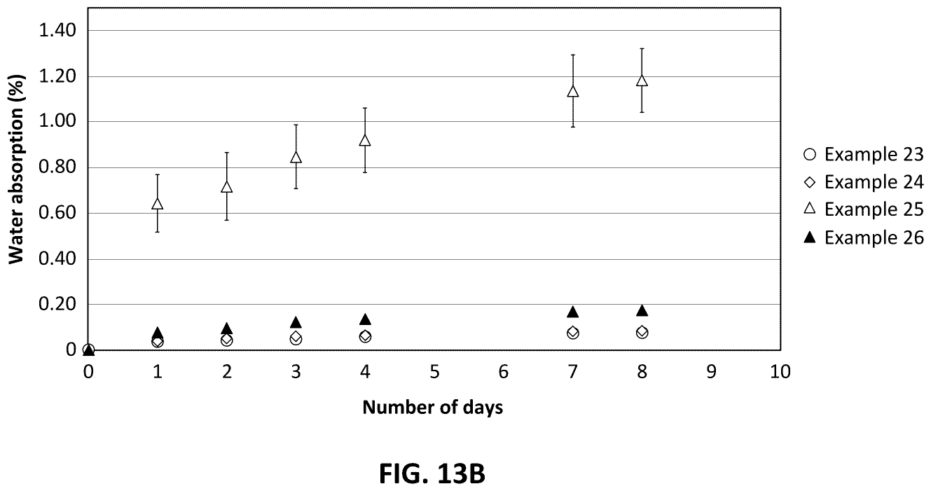

Referring now to FIGS. 13A and 13B, the water absorption rate was measured using the ASTM D570-22 (“Standard Test Method for Water Absorption of Plastics”) procedure. 3 extruded samples of each of examples 22 to 26 were tested. The samples had a length of 100 mm and were dehydrated for 24 hours in an oven at 50° C. according to ASTM D570-22 before being tested.

As can be seen in FIGS. 13A and 13B, all examples 22 to 26 had less than 1.5% water absorption after 10 days and examples 22 to 24 and 26 showed less than 0.25% water absorption after 10 days.

### Examples 27 to 33

Further examples of composite mixtures of 80-100% wt HDPE/LDPE at a ratio of HDPE to LDPE of 70:30 and 0-20% wt gypsum were made. Examples 28, 30, 32, and 33 included Hydrocerol™ 1514 as a foaming agent. The composites of examples 27 to 33 are summarized below in Table 14.

TABLE 14

| | | | | Estimated |
|---|---|---|---|---|
| | Plastic polymer (% wt) | Gypsum | Foaming | weight |
| Ex. | (HDPE:LDPE = 70:30) | (% wt) | Agent (%*) | reduction (%) |
| 27 | 100 | 0 | 0 | Reference |
| 28 | 100 | 0 | 2 | −24% |
| 29 | 90 | 10 | 0 | +5% |
| 30 | 90 | 10 | 2 | −21% |
| 31 | 80 | 20 | 0 | +9% |
| 32 | 80 | 20 | 2 | −15% |
| 33 | 80 | 20 | 1 | −21% |

*The concentration of foaming agent is given in relation to the amount of the total plastic polymer and gypsum mixture.

### Compounding Step

A Leistritz™ 34 mm co-rotating twin-screw extruder was used to compound the plastic polymer and gypsum. The twin-screw extruder includes a screw configuration that is suitable for mixing particulate composites (dispersive and distributive mixture elements) and a degassing port or zone. The twin-screw extruder compounded the plastic polymer and the gypsum while removing excess moisture therein. A thermogravimetric moisture analysis was conducted on the gypsum, indicating that the non-dried gypsum had a moisture content of about 13% wt. An air-cooling mat and a granulator were used on the extruded product to create plastic polymer/gypsum compounded granules or extrudate that can be used in the extruder. 20 kg of each formulation were extruded.

### Extruding and Foaming

The extrusion foaming was conducted using a 1.5-inch Flag single-screw extruder using a 4-hole die and conformer, a cooling water basin, and a puller. For examples 28, 30, 32, and 33, the foaming agent, in a particulate form, was added into the extruder with the plastic polymer/gypsum compounded extrudate. The foaming agent was Hydrocerol™ 1514. For examples 27, 29, and 31, the plastic polymer/gypsum compounded extrudate was added to the single-screw extruder. The extruder was operated at about 130° C. to 170° C. The flow rate was controlled by the speed of rotation of the screws, which was adjusted for each formulation to fill the die and the conformer to obtain a proper profile. The linear flow rate was about 25 to 30 cm/min.

It was observed that all non-foamed mixtures (examples 27, 29, and 31) resulted in profiles that retained their shape well and had a nice surface appearance. It was observed that each of the plastic polymer/gypsum mixtures were capable of forming foams. However, the foamability of the mixtures decreased with the increase in gypsum concentration. The foamed mixtures (examples 28, 30, 32, and 33) showed between 10% and 24% reduction in weight when compared with the same non-foamed composition. The extruded profiles of examples 28 and 30 retained their shape well and had an acceptable surface appearance. The extruded profile of example 32 resulted in the formation of coarse bubbles and foaming that continued out of the conformer, leading to a blistered surface appearance. Example 33 included a reduced amount of foaming agent (1% wt of the plastic polymer/gypsum composite material) than example 32 (50% less foaming agent). The extruded profiles of example 33 had an acceptable surface appearance, however some shrinkage was observed. The weight reduction achieved by 1% foaming agent was about 21%, which is 6% higher than example 32, which included twice as much foaming agent.

Although embodiments have been described in detail with particular reference to specific examples, other embodiments can achieve the same results. Variations and modifications of the composite materials described herein will be obvious to those skilled in the art and it is intended to cover in the appended claims all such modifications and equivalents.

What is claimed is:

1. A composite material, the composite material comprising:
at least 40% w/w of a plastic polymer; and
up to 45% w/w gypsum.

2. The composite material of claim 1, wherein the plastic polymer is at least one of linear low-density polyethylene (LLDPE), low-density polyethylene (LDPE), high-density polyethylene (HDPE), ultra-high-molecular-weight polyethylene (UHMWPO), cross-linked polyethylene (PEX or XLPE), medium-density polyethylene (MDPE), very-low-density (VLDPE), and acrylonitrile butadiene styrene (ABS).

3. The composite material of claim 2, wherein the plastic polymer comprises between about 65% and about 90% LLDPE or LDPE and between about 0% and about 35% HDPE.

4. The composite material of claim 2, wherein the plastic polymer comprises between about 65% and about 90% HDPE and between about 0% and about 35% LLDPE or LDPE.

5. The composite material of claim 3, wherein the plastic polymer comprises up to 10% ABS.

6. The composite material of claim 1, wherein the composite material comprises at least 65% w/w of the plastic polymer.

7. The composite material of claim 1, further comprising:
up to 15% wt filler.

8. The composite material of claim 7, wherein the filler comprises at least one of wood flour, cardboard, and saw dust.

9. The composite material of claim 1, further comprising:
between 0.2 and 6% w/w of a foaming agent, wherein the foaming agent is azodicarbonadmide (ADCA), p,p′Oxybis(benzene) sulfonyl hydrazide (OBSH), p-Toluene sulfonyl hydrazide (TSH), p-Toluene sulfonyl semicarbazide (TSS), dinitrosopenta-methylenetetramine (DNPT), 5-Phenyltetrazole (5PT), sodium bicarbonate, citric acid, sodium borohydride (SBH), or a mixture thereof.

10. The composite material of claim 9, wherein the composite material comprises between about 0.5 wt % and about 3.5 wt % citric acid.

11. The composite material of claim 9, wherein the composite material comprises between about 3 wt % and about 6 wt % sodium bicarbonate.

12. The composite material of claim 1, wherein the composite material is extruded or injection molded into a building material.

13. The composite material of claim 12, wherein the building material comprises at least one cavity.

14. The composite material of claim 13, wherein the at least one cavity has a diameter that is between about 10% and about 75% of a thickness of the building material.

15. A method of fabricating a product, the method comprising:
providing a plastic polymer and gypsum;
compounding the plastic polymer and the gypsum to produce a composite material comprising at least 40% w/w plastic polymer and up to 45% w/w gypsum; and
extruding or injection molding the composite material into a form to produce the product.

16. The method of claim 15, further comprising:
drying the gypsum prior to compounding the plastic polymer and the gypsum.

17. The method of claim 15, further comprising:
providing a devolatilization port during the compounding of the plastic polymer and the gypsum.

18. The method of claim 17, wherein the devolatilization port is provided with a pressure equal to or less than atmospheric pressure.

19. The method of claim 15, further comprising:
mixing a foaming agent with the composite material to produce a foamed composite material and wherein extruding or injection molding the composite material comprises extruding or injection molding the foamed composite material.

20. A building material comprising a composite material extruded or injection molded into a form, the composite material comprising at least 40% w/w of a plastic polymer and up to 45% w/w gypsum.
